(19) United States
(12) Patent Application Publication
(10) Pub. No.: US 2022/0337489 A1
(43) Pub. Date: Oct. 20, 2022

(54) CONTROL APPARATUS, METHOD, AND SYSTEM

(71) Applicant: NEC Corporation, Minato-ku, Tokyo (JP)

(72) Inventors: Anan Sawabe, Tokyo (JP); Takanori Iwai, Tokyo (JP)

(73) Assignee: NEC Corporation, Minato-ku, Tokyo (JP)

(21) Appl. No.: 17/641,920

(22) PCT Filed: Sep. 30, 2019
(86) PCT No.: PCT/JP2019/038454

§ 371 Date: Mar. 10, 2022

(51) Int. Cl. H04L 41/16; G06K 9/62; H04L 43/08

(52) U.S. Cl. CPC H04L 41/16; G06K 9/6262; H04L 43/08

(57) ABSTRACT

In order to provide a control apparatus achieving an efficient control of network using a machine learning, a control apparatus includes a learning unit and a storage unit. The learning unit learns an action for controlling the network. The storage unit stores learning information generated by the learning unit. The learning unit takes an action on the network. The learning unit decides a reward for the action taken on the network based on stationarity of the network after the action is taken to learn the action for controlling the network. The learning unit may give a positive reward to the action taken on the network if the network after the action is taken is in a stationary state, and give a negative reward to the action taken on the network if the network after the action is taken is in a non-stationary state.

### BACKGROUND

### Technical Field

The present invention relates to a control apparatus, a method, and a system.

### Background Art

Various services have been provided over a network with the development of communication technologies and information processing technologies. For example, video data is delivered from a server over the network to reproduce the video data on a terminal, or a robot or the like provided in a factory or the like is remotely controlled form a server.

In services and applications provided over the network as described above, efforts have been made to enhance quality perceived by an end user (QoE; Quality of Experience) or a control quality (QoC; Quality of Control).

For example, PTL 1 describes that estimation is enabled of the quality of a display waiting time in which the influence of individual web pages has been eliminated. The technique described in PTL 1 estimates quality of the display waiting time of a web page in any area and time zone based on traffic measurement data in the area and the time zone.

### CITATION LIST

### Patent Literature

[PTL 1] JP 2019-075030 A

### SUMMARY

### Technical Problem

The technique disclosed in PTL 1 described above, machine learning called a Support Vector Machine (SVM) is used. Here, in recent years, technologies related to the machine learning represented by deep learning have been developed, and a study is underway to apply the machine learning to various fields.

For example, a study is underway to apply the machine learning to controlling a game such as chess, or a robot or the like. In the case of applying the machine learning to game management, maximizing a score in the game is configured for a reward to evaluate a performance of the machine learning. In the robot controlling, achieving a goal action is configured for a reward to evaluate a performance of the machine learning. Typically, in the machine learning (reinforcement learning), the learning performance is discussed regarding a total of immediate rewards and rewards in respective episodes.

However, a case of applying the machine learning to control of network has a problem what is configured for a reward. For example, the control of network cannot suppose a presence of a score to be maximized as in the case that the machine learning is applied to the game. For example, even if maximizing a throughput in communication equipment included in network is configured for a reward, this configuration may not be necessarily proper for some services or some applications.

The present invention has a main example object to provide a control apparatus, a method, and a system contributing to achieving an efficient control of network using the machine learning.

### Solution to Problem

According to a first example aspect of the present invention, there is provided a control apparatus including: a learning unit configured to learn an action for controlling a network; and a storage unit configured to store learning information generated by the learning unit, wherein the learning unit is configured to decide a reward for an action taken on the network based on stationarity of the network after the action is taken.

According to a second example aspect of the present invention, there is provided a method including: learning an action for controlling a network; and storing learning information generated by the learning, wherein the learning includes deciding a reward for an action taken on the network based on stationarity of the network after the action is taken.

According to a third example aspect of the present invention, there is provided a system including: a learning means for learning an action for controlling a network; and a storage means for storing learning information generated by the learning means, wherein the learning means is configured to decide a reward for an action taken on the network based on stationarity of the network after the action is taken.

### Advantageous Effects of Invention

According to each of the example aspects of the present invention, provided are a control apparatus, a method, and a system contributing to achieving an efficient control of network using the machine learning. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a flowchart illustrating an example of an operation of a control apparatus according to an example embodiment;

FIG. 3 is a diagram illustrating an example of a schematic configuration of a communication network system according to a first example embodiment;

FIG. 4 is a diagram illustrating an example of a Q table;

FIG. 5 is a diagram illustrating an example of a configuration of a neural network;

FIG. 6 is a diagram illustrating an example of weights obtained by reinforcement learning;

FIG. 7 is a diagram illustrating an example of a processing configuration of a control apparatus according to the first example embodiment;

FIG. 8 is a diagram illustrating an example of information associating a feature with a network state;

FIG. 9 is a diagram illustrating an example of table information associating an action with control content;

FIG. 10 is a diagram illustrating an example of time series data of the feature;

FIG. 11 is a flowchart illustrating an example of an operation of the control apparatus in a control mode according to the first example embodiment;

FIG. 12 is a flowchart illustrating an example of an operation of the control apparatus in a learning mode according to the first example embodiment;

FIG. 13 is a diagram for describing an operation of a reinforcement learning performing unit;

FIG. 14 is a diagram illustrating an example of time series data of throughput;

FIG. 15 is a diagram for describing how to give a reward; and

FIG. 16 is a diagram illustrating an example of a hardware configuration of the control apparatus.

### DESCRIPTION OF THE EXAMPLE EMBODIMENTS

First of all, an overview of an example embodiment will be described. Note that reference signs in the drawings provided in the overview are for the sake of convenience for each element as an example to promote better understanding, and description of the overview is not to impose any limitations. Note that, in the Specification and drawings, elements to which similar descriptions are applicable are denoted by the same reference signs, and overlapping descriptions may hence be omitted.

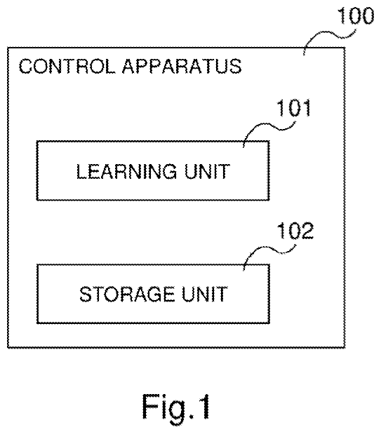

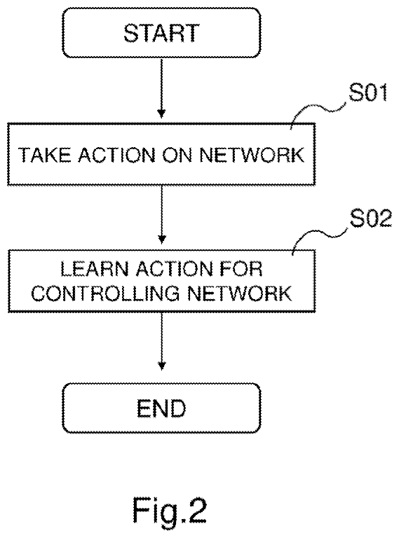

A control apparatus 100 according to an example embodiment includes a learning unit 101 and a storage unit 102 (see FIG. 1). The learning unit 101 learns an action for controlling a network. The storage unit 102 stores learning information generated by the learning unit 101. The learning unit 101 takes an action on the network (step S01 in FIG. 2). The learning unit 101 decides a reward for the action taken on the network based on stationarity of the network after the action is taken to learn the action for controlling the network (step S02 in FIG. 2).

In services and applications provided over the network, “network stability” is emphasized. The control apparatus 100 decides the reward based on stationarity of a state obtained by taking the action on the network (changing a control parameter). In other words, the control apparatus 100, when performing machine learning (reinforcement learning), recognizes that value is high in a convergent state where the network state is stable, and gives a high reward in a case of such a condition to learn for controlling the network. As a result, an efficient control of network using the machine learning is achieved.

Hereinafter, specific example embodiments are described in more detail with reference to the drawings.

### FIRST EXAMPLE EMBODIMENT

A first example embodiment will be described in further detail with reference to the drawings.

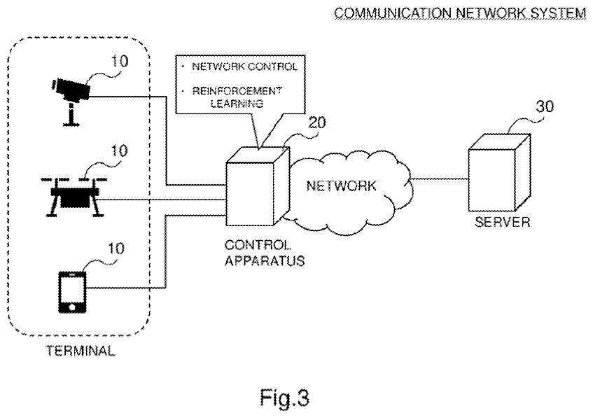

FIG. 3 is a diagram illustrating an example of a schematic configuration of a communication network system according to the first example embodiment. With reference to FIG. 3, the communication network system is configured to include a terminal 10, a control apparatus 20, and a server 30.

The terminal 10 is an apparatus having a communication functionality. Examples of the terminal 10 include a WEB camera, a security camera, a drone, a smartphone, a robot. However, the terminal 10 is not intended to be limited to the WEB camera and the like. The terminal 10 can be any apparatus having the communication functionality.

The terminal 10 communicates with the server 30 via the control apparatus 20. Various applications and services are provided by the terminal 10 and the server 30.

For example, in a case that the terminal 10 is a WEB camera, the server 30 analyzes image data from the WEB camera, so that material management in a factory or the like is performed. For example, in a case that the terminal 10 is a drone, a control command is transmitted from the server 30 to the drone, so that the drone carries a load or the like. For example, in a case that the terminal 10 is a smartphone, a video is delivered toward the smartphone from the server 30, so that a user uses the smartphone to view the video.

The control apparatus 20 is an apparatus controlling the network including the terminal 10 and the server 30, and is, for example, communication equipment such as a proxy server and a gateway. The control apparatus 20 varies values of parameters in a parameter group for a Transmission Control Protocol (TCP) or parameters in a parameter group for buffer control to control the network.

An example of the TCP parameter control includes changing a flow window size. Examples of buffer control include, in queue management of a plurality of buffers, changing the parameters related to a guaranteed minimum band, a loss rate of a Random Early Detection (RED), a loss start queue length, and a buffer length.

Note that in the following description, a parameter having an effect on communication (traffic) between the terminal 10 and the server 30, such as the TCP parameters and the parameters for the buffer control, is referred to as a “control parameter”.

The control apparatus 20 varies the control parameters to control the network. The control apparatus 20 may perform the control of network when the apparatus itself (the control apparatus 20) performs packet transfer, or may perform the control of network by instructing the terminal 10 or the server 30 to change the control parameter.

In a case that a TCP session is terminated by the control apparatus 20, for example, the control apparatus 20 may change a flow window size of the TCP session established between the control apparatus 20 and the terminal 10 to control the network. The control apparatus 20 may change a size of a buffer storing packets received from the server 30, or may change a period for reading packets from the buffer to control the network.

The control apparatus 20 uses the “machine learning” for the control of network. To be more specific, the control apparatus 20 controls the network on the basis of a learning model obtained by the reinforcement learning.

The reinforcement learning includes various variations, and, for example, the control apparatus 20 may control the network on the basis of learning information (Q table) obtained as result of the reinforcement learning referred to as Q-learning.

### [Q-Learning]

Hereinafter, the Q-learning will be briefly described.

The Q-learning makes an “agent” learn to maximize “value” in a given “environment”. In a case that the Q-learning is applied to a network system, the network including the terminal 10 and the server 30 is an “environment”, and the control apparatus 20 is made to learn to optimize a network state.

In the Q-learning, three elements, a state s, an action a, and a reward r, are defined.

The state s indicates what state the environment (network) is in. For example, in a case of the communication network system, a traffic (for example, throughput, average packet arrival interval, or the like) corresponds to the state s.

The action a indicates a possible action the agent (the control apparatus 20) may take on the environment (the network). For example, in the case of the communication network system, examples of the action a include changing configuration of parameters in the TCP parameter group, an on/off operation of the functionality, or the like.

The reward r indicates what degree of evaluation is obtained as a result of taking an action a by the agent (the control apparatus 20) in a certain state s. For example, in the case of the communication network system, the control apparatus 20 changes part of the parameters in the TCP parameter group, and as a result, if a throughput is increased, a positive reward is decided, or if a throughput is decreased, a negative reward is decided.

In the Q-learning, the learning is pursued to not maximize a reward (immediate reward) obtained at a current time point, but maximize value over a future is maximized (a Q table is established). The learning by the agent in the Q-learning is performed so that value (a Q-value, state-action value) when an action a in a certain state s is taken is maximized.

The Q-value (the state-action value) is expressed as Q(s, a). In the Q-learning, an action transitioned to a state of higher value by the agent taking the action is assumed to have value with a degree similar to a transition destination. According to such an assumption, a Q-value at a current time point t can be expressed by a Q-value at the next time point t+1 as below (see Equation (1)).

[Math. 1]

Q(sₜ,aₜ)=Eₛ_{ₜ₊₁}(rₜ₊₁+γEₐ_{ₜ₊₁}(Q(sₜ₊₁,aₜ₊₁))) (1)

Note that in Equation (1), rₜ₊₁ represents an immediate reward, Esₜ₊₁ represents an expected value for a state Sₜ₊₁, and Eaₜ₊₁ represents an expected value for an action aₜ₊₁. γ represents a discount factor.

In the Q-learning, the Q-value is updated in accordance with a result of taking an action a in a certain state s. Specifically, the Q-value is updated in accordance with Relationship (2) below.

[Math. 2]

Q(sₜ,aₜ)←(1−a)Q(sₜ,aₜ)+a(rₜ₊₁+γ maxₐ_{ₜ₊₁}Q(sₜ₊₁,aₜ₊₁)) (2)

In Relationship (2), a represents a parameter referred to as a learning rate, which controls the update of the Q-value. In Relationship (2), “max” represents a function to output a maximum value for the possible actions a in the state Sₜ₊₁. Note that a scheme for the agent (the control apparatus 20) to select the action a may be a scheme called ε-greedy.

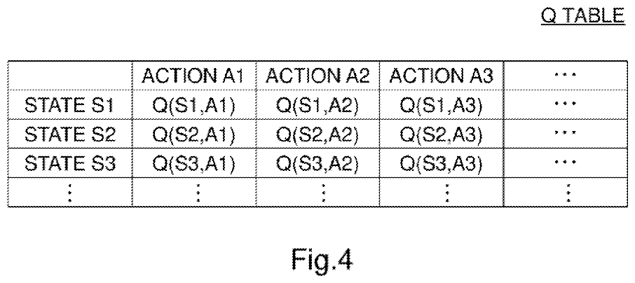

In the ε-greedy scheme, an action is selected at random with a probability ε, and an action having the highest value is selected with a probability 1−ε. Performing the Q-learning allows a Q table as illustrated in FIG. 4 to be generated.

[Learning using DQN]

The control apparatus 20 may control the network on the basis of a learning model obtained as a result of the reinforcement learning using a deep learning called Deep Q Network (DQN). The Q-learning expresses the action-value function using the Q table, whereas the DQN expresses the action-value function using the deep learning. In the DQN, an optimal action-value function is calculated by way of an approximate function using a neural network.

Note that the optimal action-value function is a function for outputting value of taking a certain action a in a certain state s.

The neural network is provided with an input layer, an intermediate layer (hidden layer), and an output layer. The input layer receives the state s as input. A link of each of nodes in the intermediate layer has a corresponding weight. The output layer outputs the value of the action a.

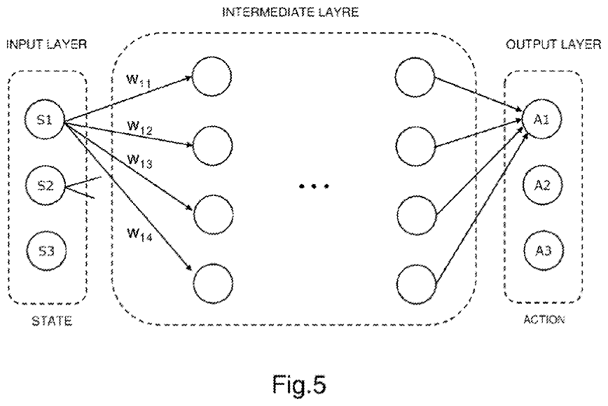

For example, consider a configuration of a neural network as illustrated in FIG. 5. Applying the neural network illustrated in FIG. 5 to the communication network system, nodes in the input layer correspond to network states S1 to S3. The network states input in the input layer are weighted in the intermediate layer and output to the output layer.

Nodes in the output layer correspond to possible actions A1 to A3 that the control apparatus 20 may take. The nodes in the output layer output values of the action-value function Q(sₜ, aₜ) corresponding to the action A1 to A3, respectively.

The DQN learns connection parameters (weights) between the nodes outputting the action-value function. Specifically, an error function E(sₜ, aₜ) expressed by Equation (3) below is set to perform learning by backpropagation.

[Math. 3]

E(sₜ,aₜ)=(rₜ₊₁+γ maxₐ_{ₜ₊₁}Q(sₜ₊₁,aₜ₊₁)−Q(sₜ,aₜ))² (3)

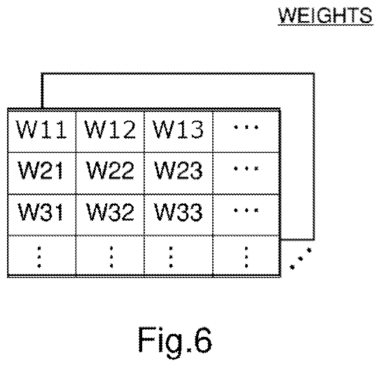

The DQN performing the reinforcement learning allows learning information (weights) to be generated that corresponds to a configuration of the intermediate layer of the prepared neural network (see FIG. 6).

Here, an operation mode for the control apparatus 20 includes two operation modes.

A first operation mode is a learning mode to calculate a learning model. The control apparatus 20 performing the “Q-learning” allows the Q table as illustrated in FIG. 4 to be calculated. Alternatively, the control apparatus 20 performing the reinforcement learning using the “DQN” allows the weights as illustrated in FIG. 6 to be calculated.

A second operation mode is a control mode to control the network using the learning model calculated in the learning mode. Specifically, the control apparatus 20 in the control mode calculates a current network state s to select an action a having the highest value of the possible actions a which may be taken in a case of the state s. The control apparatus 20 performs an operation (control of network) corresponding to the selected action a.

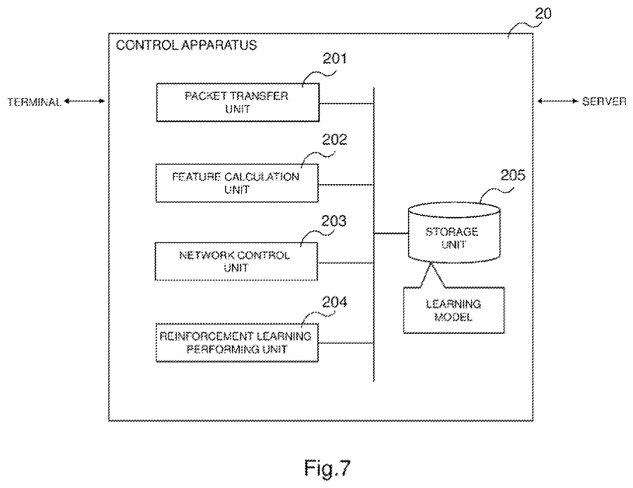

FIG. 7 is a diagram illustrating an example of a processing configuration (a processing module) of the control apparatus 20 according to the first example embodiment. With reference to FIG. 7, the control apparatus 20 is configured to include a packet transfer unit 201, a feature calculation unit 202, a network control unit 203, a reinforcement learning performing unit 204, and a storage unit 205.

The packet transfer unit 201 is a means for receiving packets transmitted from the terminal 10 or the server 30 to transfer the received packets to an opposite apparatus. The packet transfer unit 201 performs packet transfer in accordance with a control parameter notified from the network control unit 203.

For example, when the packet transfer unit 201 is notified of a configuration value of the flow window size from the network control unit 203, the packet transfer unit 201 performs the packet transfer using the notified flow window size.

The packet transfer unit 201 delivers a duplication of the received packets to the feature calculation unit 202.

The feature calculation unit 202 is a means for calculating a feature featuring a communication traffic between the terminal 10 and the server 30. The feature calculation unit 202 extracts a traffic flow to be a target of network control from the obtained packets. Note that the traffic flow to be a target of network control is a group consisting of packets having the identical source (Internet Protocol) IP address, destination IP address, port number, or the like.

The feature calculation unit 202 calculates the feature from the extracted traffic flow. For example, the feature calculation unit 202 calculates, as the feature, a throughput, an average packet arrival interval, a packet loss rate, a jitter, or the like. The feature calculation unit 202 stores the calculated feature with a calculation time in the storage unit 205. Note that the calculation of the throughput or the like can be made by use of existing technologies, and is obvious to those of ordinary skill in the art, and thus, a detailed description thereof is omitted.

The network control unit 203 is a means for controlling the network on the basis of the action obtained from the learning model generated by the reinforcement learning performing unit 204. The network control unit 203 decides the control parameter to be notified to the packet transfer unit 201 on the basis of the learning model obtained as a result of the reinforcement learning. The network control unit 203 is a module mainly operating in the control mode.

The network control unit 203 reads out the latest feature (at a current time) from the storage unit 205. The network control unit 203 estimates (calculates) a state of the network to be controlled, from the read feature.

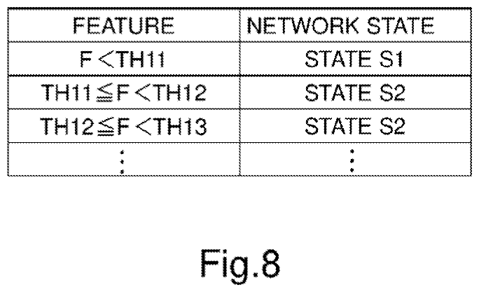

For example, the network control unit 203 references a table associating a feature F with a network state (see FIG. 8) to calculate the network state for the current feature F. Note that a traffic is caused by communication between the terminal 10 and the server 30, and thus, the network state can be recognized also as a “traffic state”. In other words, in the present disclosure, the “traffic state” and the “network state” can be interchangeably interpreted.

In a case that the learning model is established by the Q-learning, the network control unit 203 references the Q table stored in the storage unit 205 to acquire an action having the highest value Q of the actions corresponding to the current network state. For example, in the example in FIG. 4, if the calculated traffic state is a “state S1”, and value Q(S1, A1) is maximum among the value Q(S1, A1), Q(S1, A2), and Q(S1, A3), an action A1 is read out.

Alternatively, in a case that the learning model is established by the DNQ, the network control unit 203 inputs the current network state to a neural network as illustrated in FIG. 5 to acquire an action having the highest value of the possible actions.

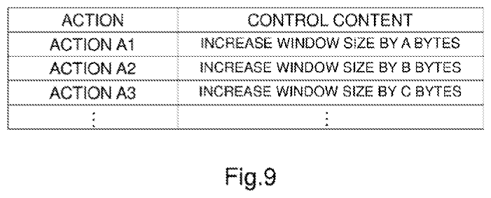

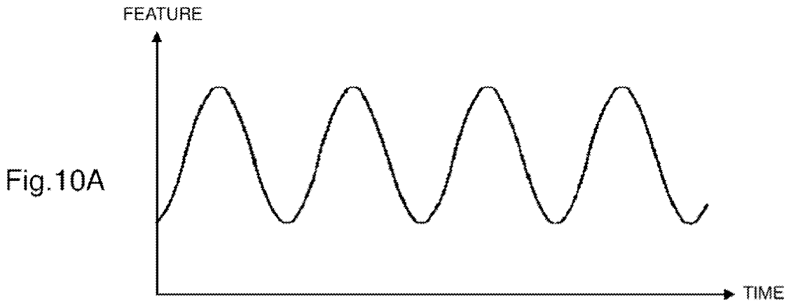

The network control unit 203 decides a control parameter depending on the acquired action to configure (notify) the decided control parameter for the packet transfer unit 201. Note that a table associating an action with control content (see FIG. 9) is stored in the storage unit 205, and the network control unit 203 references the table to decide the control parameter to be configured for the packet transfer unit 201.

For example, as illustrated in FIG. 9, in a case that changed content (updated content) of the control parameter is described as control content, the network control unit 203 notifies the packet transfer unit 201 of the control parameter depending on the changed content.

The reinforcement learning performing unit 204 is a means for learning an action for controlling a network (a control parameter). The reinforcement learning performing unit 204 performs the reinforcement learning by the Q-learning or the DQN described above to generate a learning model. The reinforcement learning performing unit 204 is a module mainly operating in the learning mode.

The reinforcement learning performing unit 204 calculates the network state s at the current time t from the feature stored in the storage unit 205. The reinforcement learning performing unit 204 selects an action a from among the possible actions a in the calculated state s by a method like the ε-greedy scheme. The reinforcement learning performing unit 204 notifies the packet transfer unit 201 of the control content (the updated value of the control parameter) corresponding to the selected action. The reinforcement learning performing unit 204 decides a reward in accordance with a change in the network depending on the action. At this time, the reinforcement learning performing unit 204 decides the reward for the action taken on the network based on stationarity of the network after the action is taken.

Specifically, the reinforcement learning performing unit 204 decides, as a result of taking the action a, the reward on the basis of whether or not the network is in a stationary state. The reinforcement learning performing unit 204, in deciding a reward rₜ₊₁ described in Relationship (2) or Equation (3), gives a positive reward if the network is in the stationary state (or if the network is stable). In contrast, if the network state is in a non-stationary state (or if the network is unstable), the reinforcement learning performing unit 204 gives a negative reward.

The reinforcement learning performing unit 204 performs statistical processing on time series data for the network state varied by taking the action on the network to determine the stationarity of the network.

Specifically, the reinforcement learning performing unit 204 reads out features (time series data of a feature) until a prescribed time period before the next time t+1 after performing the control of network corresponding to the action a selected by a method like the ε-greedy scheme. The reinforcement learning performing unit 204 performs the statistical processing on the time series data of the feature as read out to calculate an evaluation index indicating whether or not the network state is in the stationary state.

Specifically, the reinforcement learning performing unit 204 models the time series data using an Autoregressive model (AR model). The AR model expresses the time series data x1, x2, . . . , xN as a value of the current time by addition (linear sum) of weighted past values as expressed in Equation (4) below.

[Math. 4]

x(t)=c+Σᵢ₌₁^{p}wᵢx(t−i)+∈(t) (4)

In Equation (4), x(t) represents a feature, ε(t) represents a noise (white noise), c represents a constant not changing with time, and wᵢ represents a weight. i is a suffix for specifying a past time, and p is an integer specifying a prescribed time period before.

The reinforcement learning performing unit 204 estimates the weight wᵢ described in Equation (4) using the time series data read from the storage unit 205. Specifically, the reinforcement learning performing unit 204 estimates the weight wᵢ using a parameter estimation scheme such as the maximum-likelihood method and the Yule-Walker equation. Note that the parameter estimation scheme such as the maximum-likelihood method and the Yule-Walker equation to be employed may be publicly known technology, and thus, a detailed description thereof is omitted.

Next, the reinforcement learning performing unit 204 performs a unit root test on the AR model obtained from the time series data. The reinforcement learning performing unit 204 performs the unit root test to obtain a stationary degree (a degree of stationarity) of the time series data. The reinforcement learning performing unit 204 can calculate a ratio of “stationarity” to “non-stationarity” by performing the unit root test. The unit root test can be achieved by an existing algorithm and is obvious to those of ordinary skill in the art, and thus, a detailed description thereof is omitted.

The reinforcement learning performing unit 204 performs threshold processing (for example, processing to determine whether an obtained value is not less than, or less than a threshold) on the stationary degree obtained by the unit root test to determine whether or not the network state is the stationary state. In other words, the reinforcement learning performing unit 204 determines whether the network state is the “non-stationary state” that is transitional toward the stationary state or the “stationary state” that is converged centered on a specific value.

Specifically, the reinforcement learning performing unit 204 determines that the network state is “stationary” if the stationary degree is not less than the threshold. The reinforcement learning performing unit 204 determines that the network state is “non-stationary” if the stationary degree is less than the threshold.

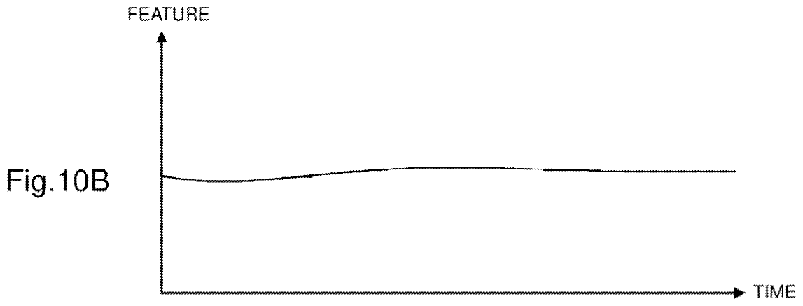

FIG. 10 is a diagram illustrating an example of the time series data of the feature. In a case that the reinforcement learning performing unit 204 performs the unit root test on the time series data illustrated in FIG. 10A, the network state is determined to be “non-stationary”.

In this case, the reinforcement learning performing unit 204 gives a negative reward (for example, −1) to the reward rₜ₊₁ in Relationship (2) or Equation (3) to update the Q table or the weights. In contrast, in a case that the reinforcement learning performing unit 204 performs the unit root test on the time series data illustrated in FIG. 10B, the network state is determined to be “stationary”. In this case, the reinforcement learning performing unit 204 gives a positive reward (for example, +1) to the reward rₜ₊₁ in Relationship (2) or Equation (3) to update the Q table or the weights.

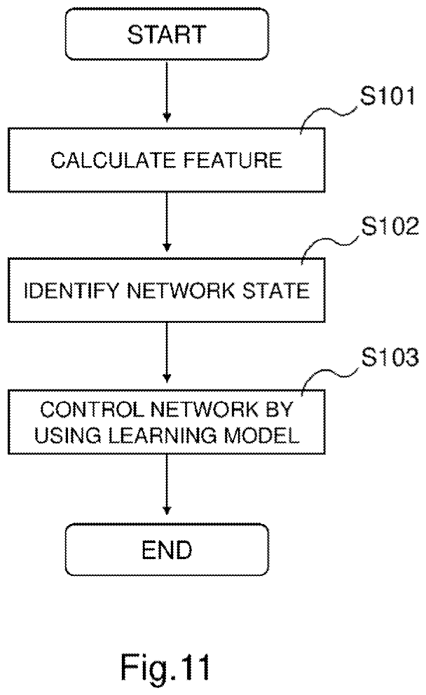

Summarizing the operations of the control apparatus 20 in the control mode according to the first example embodiment, a flowchart as illustrated in FIG. 11 is obtained.

The control apparatus 20 acquires packets to calculate a feature (step S101). The control apparatus 20 identifies a network state on the basis of the calculated feature (step S102). The control apparatus 20 uses the learning model to control the network using an action having the highest value depending on the network state (step S103).

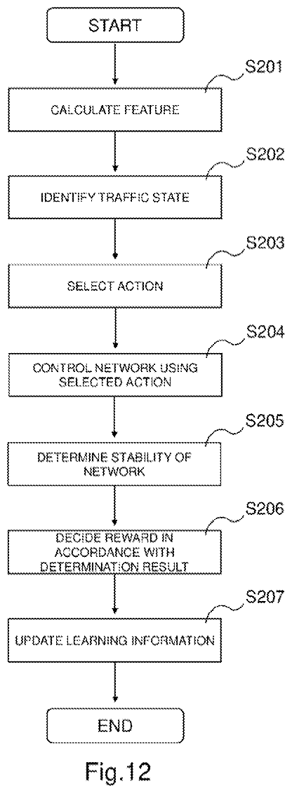

Summarizing the operations of the control apparatus 20 in the learning mode according to the first example embodiment, a flowchart as illustrated in FIG. 12 is obtained.

The control apparatus 20 acquires packets to calculate a feature (step S201). The control apparatus 20 identifies a network state on the basis of the calculated feature (step S202). The control apparatus 20 selects a possible action which may be taken in the current network state by the ε-greedy scheme or the like (step S203). The control apparatus 20 controls the network using the selected action (step S204). The control apparatus 20 uses time series data of the feature to determine stationarity of the network (step S205). The control apparatus 20 decides a reward in accordance with a determination result (step S206) to update learning information (Q table, weight) (step S207).

Subsequently, the operation of the control apparatus 20 is specifically described for each type of the terminal 10.

[In Case that Terminal is Drone]

In a case that the terminal 10 is a drone, selected as an index (feature) indicating the network state is, for example, an average packet arrival interval of packets transmitted from the drone toward the server 30. The server 30 transmits control packets (the packets including a control command) to the drone. An average packet arrival interval of response packets (a positive response or a negative response) from the drone with respect to the control packets is selected as a feature.

The control apparatus 20 decides the control parameter to control the network such that an interval of packet transmission/reception between the server 30 and the drone is stable. The possible actions (changeable control parameters) in the case that the terminal 10 is a drone may include a packet reading interval (a packet transmission interval) from a buffer storing the control packets acquired from the server 30.

The reinforcement learning performing unit 204 learns a parameter for reading out the control packets from the buffer such that the average packet arrival interval of the response packets transmitted from the drone to the server 30 is stable. In an application in which the server 30 remotely controls the drone (to be controlled), an emphasis is put on stable arrival, to a counter side, of the packets (control packets or response packets) transmitted/received between the drone and the server 30.

Here, a packet size of the control packets or the response packets is not so large. For this reason, the value in controlling the drone is higher in a situation where a throughput from the server 30 is low although the packet transmission/reception is stable than in a situation where the throughput is high although the packet transmission/reception is not stable (or a situation where a large amount of information can be transmitted at one time although arrivals of the packets are varied).

The control apparatus 20 according to the first example embodiment can achieve the network control proper for the application that remotely controls the drone by properly selecting the feature featuring the network state (the traffic state) (for example, by selecting the average packet arrival interval).

[In Case that Terminal is WEB Camera]

In the description, the case that the stationarity of the network is used as the condition (criterion) for deciding the reward rₜ₊₁ is described, but another criterion may be added to the stationarity to decide the reward rₜ₊₁. Here, a case that the terminal 10 is a WEB camera is used as an example to describe a case that an item other than “the stationarity of the network” is considered to decide the reward rₜ₊₁.

In the case that the terminal 10 is a WEB camera, selected as the index (feature) indicating the network state is, for example, a throughput of a traffic flowing from the WEB camera to the server 30. The reinforcement learning performing unit 204 calculates a learning model such that the throughput from the WEB camera to the server 30 is stable around a target value.

For example, a flow window size of a TCP session established between the terminal 10 and the server 30 is configured as the control parameter, and an action is learned such that the goal (the throughput is stable at the target value) is achieved. The reinforcement learning performing unit 204 uses time series data the feature (throughput) calculated by the feature calculation unit 202 to determine the stationarity of the network.

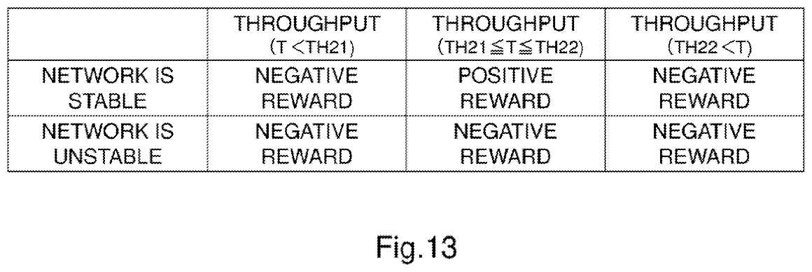

Subsequently, the reinforcement learning performing unit 204 decides the reward r₊₁ depending on a range of the feature (throughput). For example, if the target value is equal to or more than a threshold TH21 and equal to or less than a threshold TH22, the reinforcement learning performing unit 204 decides the reward rₜ₊₁ on the basis of a policy as illustrated in FIG. 13. The network is controlled by use of the learning model obtained by such a method of giving the reward such that the throughput from the WEB camera is stable around the targeted value.

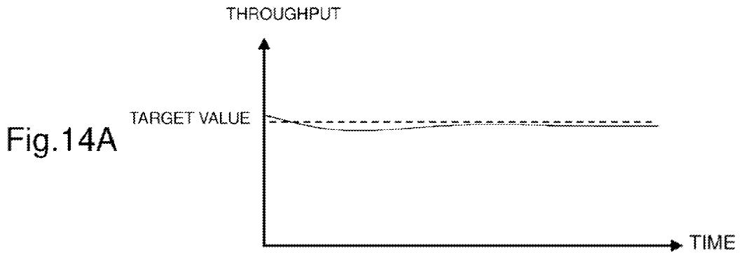

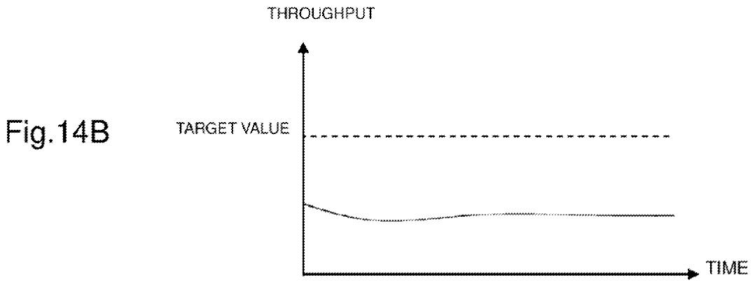

Specifically, the network control by the control apparatus 20 can achieve the network state as illustrated in FIG. 14A (the throughput is stable around the target value). In other words, the range of the throughput is taken into consideration to decide the reward r₊₁, which prevents the network state from being brought into that as illustrated in FIG. 14B. In FIG. 14B, although the network state is eventually stable, a throughput at a stationary time is largely deviated from the target value.

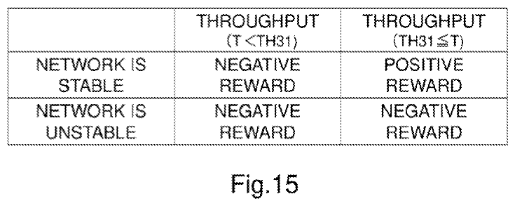

Note that FIG. 13 illustrates a case that a positive reward is given if the throughput is in a prescribed range, but a positive reward may be given in a case that the throughput is equal to or more than a prescribed value (see FIG. 15). In contrast to the situation in FIG. 14B, in a case that the throughput is allowed to be stable at a high value far from the target value, the reward rₜ₊₁ may be decided as illustrated in FIG. 15.

A limitation put on the throughput may be decided in consideration of resources (communication resources) for the control apparatus 20. For example, in the case that a flow window size selected for the control parameter, the throughput is considered to be stable at a high value if the window size is increased. However, in order to prepare the large flow window size, a memory (resource) consumption is increased to decrease the resources allocable to another terminal 10. The control apparatus 20 may take merits and demerits as described above into consideration to decide the table update policy.

[In Case that Terminal is Smartphone]

The above description describes the case that one feature is used to determine the stationarity of the network, and the like, but a plurality of features may be used to determine the stationarity of the network, and the like. Hereinafter, a case that the terminal 10 is a smartphone is used as an example to describe a case that the stationarity of the network is determined using a plurality of feature.

Here, assume a case that a video is delivered from the server 30 and the video is reproduced by the smartphone (the terminal 10). The future calculation unit 202 calculates a throughput of a traffic flowing from the server 30 to the smartphone and an average packet arrival interval.

The reinforcement learning performing unit 204 determines the stationarity of the network from those two features. Specifically, the reinforcement learning performing unit 204 determines whether or not the throughput is stable on the basis of time series data of the throughput. Similarly, the reinforcement learning performing unit 204 determines whether or not the average packet arrival interval is stable on the basis of time series data of the average packet arrival interval.

The reinforcement learning performing unit 204 determines that the network is in the stationary state and gives a positive reward to reward rₜ₊₁ in a case that both the throughput and the average packet arrival interval are in the stationary state, otherwise gives a negative reward.

As described above, the control apparatus 20 according to the first example embodiment estimates the network state by using the feature featuring the traffic flowing in the network. The control apparatus 20 decides the reward for an action depending on the time series variation of the state obtained by taking the action on the network (changing the control parameter). Accordingly, the “network stability” demanded on the level of services and applications provided over the network is given a high reward, which can achieve improvement in network quality proper for the application and the like. In other words, in the present disclosure, in a case of the reinforcement learning, the value is recognized to be high in the convergent state where the network state is stable, and in the case of such a situation, a learner is considered to be able to adapt to the environment (network), and then, the reward is decided.

### SECOND EXAMPLE EMBODIMENT

Subsequently, a second example embodiment is described in detail with reference to the drawings.

In the first example embodiment, the network state is estimated using the feature (for example, the throughput) featuring the traffic flowed in the network. In the second example embodiment, a case of deciding the network state on the basis of the QoE (quality of experience) or the QoC (quality of control) in the terminal 10 will be described.

For example, assume a case that the terminal 10 is a smartphone, and a video reproducing application is operating. In this case, the terminal 10 notifies the control apparatus 20 of an image quality of the reproduced video, a bit rate, the number of blackouts (the number of times when a buffer becomes empty), a frame rate, and the like. Alternatively, the terminal 10 may transmit a Mean Opinion Score (MOS) value that is defined in International Telecommunication Union (ITU)-T Recommendation P.1203 to the control apparatus 20.

Alternatively, in a case that a WEB page is viewed in the smartphone (a browser operates), the terminal 10 may notify the control apparatus 20 of an initial standby time until the page is displayed.

For example, in a case that the terminal 10 is a robot, the robot may notify the control apparatus 20 of a reception interval of the control command, a work complete time, the number of times of work success, and the like.

Alternatively, in a case that the terminal 10 is a security camera, the security camera may notify the control apparatus 20 of an authentication rate and the number of times of authentication of a monitored target (for example, a person's face, an object, or the like), and the like.

The control apparatus 20 may acquire a value indicating the QoE in the terminal 10 (for example, the initial standby time, or the like) from the terminal 10, and determine the stationarity of the network on the basis of the value to decide the reward rₜ₊₁. At this time, the control apparatus 20 may perform, in a similar way to the method described in the first example embodiment, the unit root test on time series data of the QoE acquired from the terminal 10 to evaluate the stationarity of the network.

Alternatively, the control apparatus 20 may estimate the value indicating the QoE from the traffic flowing between the terminal 10 and the server 30. For example, the control apparatus 20 may estimate the bit rate from the throughput to determine the stationarity of the network on the basis of the estimated value. Note that when estimating the bit rate from the throughput, a method described in a reference document 1 below may be used.

### [Reference Document 1] WO 2019/044065

As described above, the control apparatus 20 according to the second example embodiment estimates the network state from the quality of experience (QoE) or the quality of control (QoC), and may give a high reward in the case that the quality of experience is stable. For example, assume a case that a user uses a terminal to view a video. In this case, in the present disclosure, the network quality is determined to be higher in a network environment where the frame rate is constant even if the frame rate is low than in a network environment where the frame rate frequently changes (an environment where the frame rate is not stable). In other words, the control apparatus 20 learns the control parameter achieving such a high network quality by the reinforcement learning.

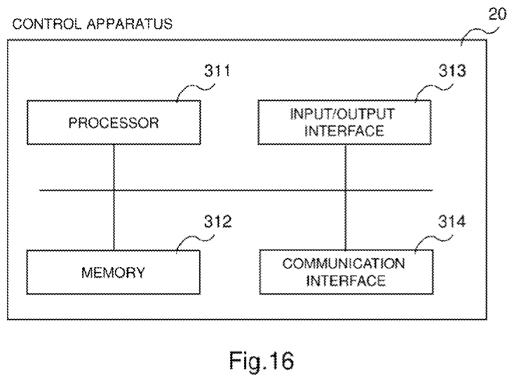

Next, hardware of each apparatus configuring the communication network system will be described. FIG. 16 is a diagram illustrating an example of a hardware configuration of the control apparatus 20.

The control apparatus 20 can be configured with an information processing apparatus (so-called, a computer), and includes a configuration illustrated in FIG. 16. For example, the control apparatus 20 includes a processor 311, a memory 312, an input/output interface 313, a communication interface 314, and the like. Constituent elements such as the processor 311 are connected to each other with an internal bus or the like, and are configured to be capable of communicating with each other.

However, the configuration illustrated in FIG. 16 is not intended to limit the hardware configuration of the control apparatus 20. The control apparatus 20 may include hardware not illustrated, or need not include the input/output interface 313 as necessary. The number of processors 311 and the like included in the control apparatus 20 is not intended to limit to the example illustrated in FIG. 16, and for example, a plurality of processors 311 may be included in the control apparatus 20.

The processor 311 is, for example, a programmable device such as a central processing unit (CPU), a micro processing unit (MPU), and a digital signal processor (DSP). Alternatively, the processor 311 may be a device such as a field programmable gate array (FPGA) and an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display apparatus and an input apparatus (not illustrated). The display apparatus is, for example, a liquid crystal display or the like. The input apparatus is, for example, an apparatus that receives user operation, such as a keyboard and a mouse.

The communication interface 314 is a circuit, a module, or the like that performs communication with another apparatus. For example, the communication interface 314 includes a network interface card (NIC) or the like.

The function of the control apparatus 20 is implemented by various processing modules. Each of the processing modules is, for example, implemented by the processor 311 executing a program stored in the memory 312. The program can be recorded on a computer readable storage medium. The storage medium can be a non-transitory storage medium, such as a semiconductor memory, a hard disk, a magnetic recording medium, and an optical recording medium. In other words, the present invention can also be implemented as a computer program product. The program can be updated through downloading via a network, or by using a storage medium storing a program. In addition, the processing module may be implemented by a semiconductor chip.

Note that the terminal 10 and the server 30 also can be configured by the information processing apparatus similar to the control apparatus 20, and their basic hardware structures are not different from the control apparatus 20, and thus, the descriptions thereof are omitted.

### EXAMPLE ALTERATIONS

Note that the configuration, the operation, and the like of the communication network system described in the example embodiments are merely examples, and are not intended to limit the configuration and the like of the system. For example, the control apparatus 20 may be separated into an apparatus controlling the network and an apparatus generating the learning model. Alternatively, the storage unit 205 storing the learning information (the learning model) may be achieved by an external database server or the like. In other words, the present disclosure may be implemented as a system including a learning means, a control means, a storage means, and the like.

In the example embodiments, the unit root test is performed on the time series data of the feature to calculate the stationary degree of the network. However, the stationary degree of the network may be calculated by use of another index. For example, the reinforcement learning performing unit 204 may calculate a standard deviation indicating a variation degree of the data, and determine that the network is in the stationary state in a case that “average—standard deviation” is equal to or more than a threshold.

In the example embodiments, one threshold is used to determine the stationarity (the stability) of the network, but a plurality of thresholds may be used to more finely calculate the degree of stationarity of the network. For example, the stationarity of the network may be determined in four states such as “extremely stable”, “stable”, “unstable”, and “extremely unstable”. In this case, the reward may be decided depending on the degree of stationarity of the network.

Note that the terminal 10 may be a sensor apparatus in some cases. The sensor apparatus generates a communication pattern (communication traffic) in accordance with an on/off model. Specifically, if the terminal 10 is a sensor apparatus or the like, there may occur a case that the data (packets) flows over the network and a case of not flowing (a no-communication state). For this reason, the stationarity may be determined using a variation pattern rather than by the control apparatus 20 performing stationarity determination (unit root test) using the time series data of the traffic (the feature) as it is. The control apparatus 20 may use time series data of the time interval of the up-and-down feature to determine the stationarity of the network. Alternatively, the control apparatus 20, in a case of grasping an application in accordance with the on/off model in advance, may not reflect the no-communication state to the reward, and so on. Specifically, the control apparatus 20 may give a reinforcement learning reward in a case that the network state is in a “communication state”.

The example embodiments describe the case that the control apparatus 20 use the traffic flow as a target of control (as one unit of control). However, the control apparatus 20 may use an individual the terminal 10 or a group collecting a plurality of terminals 10 as a target of control. Specifically, the flows even in the identical terminal 10 are handled as different flows because if the applications are different, port numbers are different. The control apparatus 20 may apply the same control (changing the control parameter) to the packets transmitted from the identical terminal 10. Alternatively, the control apparatus 20 may handle, for example, the same type of terminals 10 as one group to apply the same control to the packets transmitted from the terminals 10 belonging to the same group.

In a plurality of flowcharts used in the above description, a plurality of steps (processes) are described in order, but the order of performing of the steps performed in each example embodiment is not limited to the described order. In each example embodiment, the illustrated order of processes can be changed as far as there is no problem with regard to processing contents, such as a change in which respective processes are executed in parallel, for example. The example embodiments described above can be combined within a scope that the contents do not conflict.

The whole or part of the example embodiments disclosed above can be described as in the following supplementary notes, but are not limited to the following.

### (Supplementary Note 1)

A control apparatus (20, 100) including:

a learning unit (101, 204) configured to learn an action for controlling a network; and

a storage unit (102, 205) configured to store learning information generated by the learning unit (101, 204),

wherein the learning unit is configured to decide a reward for an action taken on the network based on stationarity of the network after the action is taken.

### (Supplementary Note 2)

The control apparatus (20, 100) according to supplementary note 1, wherein

the learning unit (101, 204) is configured to

give a positive reward to the action taken on the network in a case that the network after the action is taken is in a stationary state, and

give a negative reward to the action taken on the network in a case that the network after the action is taken is in a non-stationary state.

### (Supplementary Note 3)

The control apparatus (20, 100) according to supplementary note 1 or 2, wherein the learning unit (101, 204) is configured to determine the stationarity of the network based on time series data for a network state varied by taking the action on the network.

### (Supplementary Note 4)

The control apparatus (20, 100) according to supplementary note 3, wherein the learning unit (101, 204) is configured to estimate the network state using at least one of a feature featuring a traffic flowing over the network, quality of experience, and quality of control.

### (Supplementary Note 5)

The control apparatus (20, 100) according to any one of supplementary notes 1 to 4, further including:

a control unit (203) configured to control the network based on an action obtained from a learning model generated by the learning unit (101, 204).

### (Supplementary Note 6)

A method including:

learning an action for controlling a network; and

storing learning information generated by the learning,

wherein the learning includes deciding a reward for an action taken on the network based on stationarity of the network after the action is taken.

### (Supplementary Note 7)

The method according to supplementary note 6, wherein the learning includes

giving a positive reward to the action taken on the network in a case that the network after the action is taken is in a stationary state, and

giving a negative reward to the action taken on the network in a case that the network after the action is taken is in a non-stationary state.

### (Supplementary Note 8)

The method according to supplementary note 6 or 7, wherein the learning includes determining the stationarity of the network based on time series data for a network state varied by taking the action on the network.

### (Supplementary Note 9)

The method according to supplementary note 8, wherein the learning includes estimating the network state using at least one of a feature featuring a traffic flowing over the network, quality of experience, and quality of control.

### (Supplementary Note 10)

The method according to any one of supplementary notes 6 to 9, further including:

controlling the network based on an action obtained from a learning model generated by the learning.

### (Supplementary Note 11)

A system including:

a learning means (101, 204) for learning an action for controlling a network; and

a storage means (102, 205) for storing learning information generated by the learning means (101, 204),

wherein the learning means (101, 204) is configured to decide a reward for an action taken on the network based on stationarity of the network after the action is taken.

### (Supplementary Note 12)

The system according to supplementary note 11, wherein the learning means (101, 204) is configured to

give a positive reward to the action taken on the network in a case that the network after the action is taken is in a stationary state, and

give a negative reward to the action taken on the network in a case that the network after the action is taken is in a non-stationary state.

### (Supplementary Note 13)

The system according to supplementary note 11 or 12, wherein the learning means (101, 204) is configured to determine the stationarity of the network based on time series data for a network state varied by taking the action on the network.

### (Supplementary Note 14)

The system according to supplementary note 13, wherein the learning means (101, 204) is configured to estimate the network state using at least one of a feature featuring a traffic flowing over the network, quality of experience, and quality of control.

### (Supplementary Note 15)

The system according to any one of supplementary notes 11 to 14, further including:

a control means (203) for controlling the network based on an action obtained from a learning model generated by the learning means (101, 204).

### (Supplementary Note 16)

A program causing a computer (311) to execute the processing of:

learning an action for controlling a network; and

storing learning information generated by the learning,

wherein the learning includes deciding a reward for an action taken on the network based on stationarity of the network after the action is taken.

Note that the disclosures of the cited literatures in the citation list are incorporated herein by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

### REFERENCE SIGNS LIST

10 Terminal
20, 100 Control Apparatus
30 Server
101 Learning Unit
102, 205 Storage Unit
201 Packet Transfer Apparatus
202 Feature Calculation Unit
203 Network Control Unit
204 Reinforcement Learning Performing Unit
311 Processor
312 Memory
313 Input/Output Interface
314 Communication Interface

What is claimed is:

1. A control apparatus comprising:
a memory storing instructions; and
one or more processors configured to execute the instructions to
learn an action for controlling a network; and
store, in the memory, learning information generated by the learning,
wherein the one or more processors are configured to decide a reward for an action taken on the network based on stationarity of the network after the action is taken.

2. The control apparatus according to claim 1, wherein
the one or more processors are configured to
give a positive reward to the action taken on the network in a case that the network after the action is taken is in a stationary state, and
give a negative reward to the action taken on the network in a case that the network after the action is taken is in a non-stationary state.

3. The control apparatus according to claim 1, wherein the one or more processors are configured to determine the stationarity of the network based on time series data for a network state varied by taking the action on the network.

4. The control apparatus according to claim 3, wherein the one or more processors are configured to estimate the network state using at least one of a feature featuring a traffic flowing over the network, quality of experience, and quality of control.

5. The control apparatus according to claim 1, wherein
the one or more processors are configured to control the network based on an action obtained from a learning model.

6. A method comprising:
learning an action for controlling a network; and
storing learning information generated by the learning,
wherein the learning includes deciding a reward for an action taken on the network based on stationarity of the network after the action is taken.

7. The method according to claim 6, wherein the learning includes
giving a positive reward to the action taken on the network in a case that the network after the action is taken is in a stationary state, and
giving a negative reward to the action taken on the network in a case that the network after the action is taken is in a non-stationary state.

8. The method according to claim 6, wherein the learning includes determining the stationarity of the network based on time series data for a network state varied by taking the action on the network.

9. The method according to claim 8, wherein the learning includes estimating the network state using at least one of a feature featuring a traffic flowing over the network, quality of experience, and quality of control.

10. The method according to claim 6, further comprising:
controlling the network based on an action obtained from a learning model generated by the learning.

11. A system comprising:
a learning apparatus including a memory storing instructions, and one or more processors configured to execute the instructions to learn an action for controlling a network; and
a storage apparatus configured to store learning information generated by the learning apparatus,
wherein the one or more processors are configured to decide a reward for an action taken on the network based on stationarity of the network after the action is taken.

12. The system according to claim 11, wherein the one or more processors are configured to
give a positive reward to the action taken on the network in a case that the network after the action is taken is in a stationary state, and
give a negative reward to the action taken on the network in a case that the network after the action is taken is in a non-stationary state.

13. The system according to claim 11, wherein the one or more processors are configured to determine the stationarity of the network based on time series data for a network state varied by taking the action on the network.

14. The system according to claim 13, wherein the one or more processors are configured to estimate the network state using at least one of a feature featuring a traffic flowing over the network, quality of experience, and quality of control.

15. The system according to claim 11, further comprising:
a control apparatus configured to control the network based on an action obtained from a learning model generated by the learning apparatus.
